(19) United States
(12) Patent Application Publication
(10) Pub. No.: US 2010/0065690 A1
(43) Pub. Date: Mar. 18, 2010

(54) Emergency evacuation unit

(76) Inventor: Linda J. Hunt, Durham, NC (US)

Correspondence Address: Linda Jones Hunt, 2806 Framer Lane, Durham, NC, 27704, US

(21) Appl. No.: 11/902,822

(22) Filed: Sep. 25, 2007

(51) Int. Cl. B64D 17/62

(52) U.S. Cl. 244/149

(57) ABSTRACT

Having described and examined the nature of my invention and the manner in which it is to perform, I claim:
1. A parachute comprising of one canopy having devices attached to harness and cords connecting to said harness to the other edge of the canopy in combination connected to devices which automatically deploys canopy in 2 seconds and also informs user of correct procedures on use of said parachute with the added feature of a pull cord which may be considered an important improvement from the point of a safety factor.

### FIELD OF THE INVENTION

This invention relates to a parachute having a single canopy with a manual pull cord as a back-up to release the parachute. It also has a optional inflation device in the event of panic. It is compact in size and easy to use to allow persons facing an emergency situation to escape from a high rise building to the ground.

### BACKGROUND OF THE INVENTION

The purpose of this invention is to help save lives in the event of terrorist attack, bombing, fire or any emergency situation. Due to the size of the conventional parachute, which is too large and bulky which makes it not suitable for this purpose as well as the timing to deploy of the normal parachute would not give the canopy time to inflate which would case fatalities.

Realizing that there were no efficient methods to ensure the survival of people trapped in high places, I invented one, The LifePac Parachute. The LifePac is invented to provide an alternate easy way to escape an emergency situation from a high-rise building.

### DESCRIPTION OF DRAWING

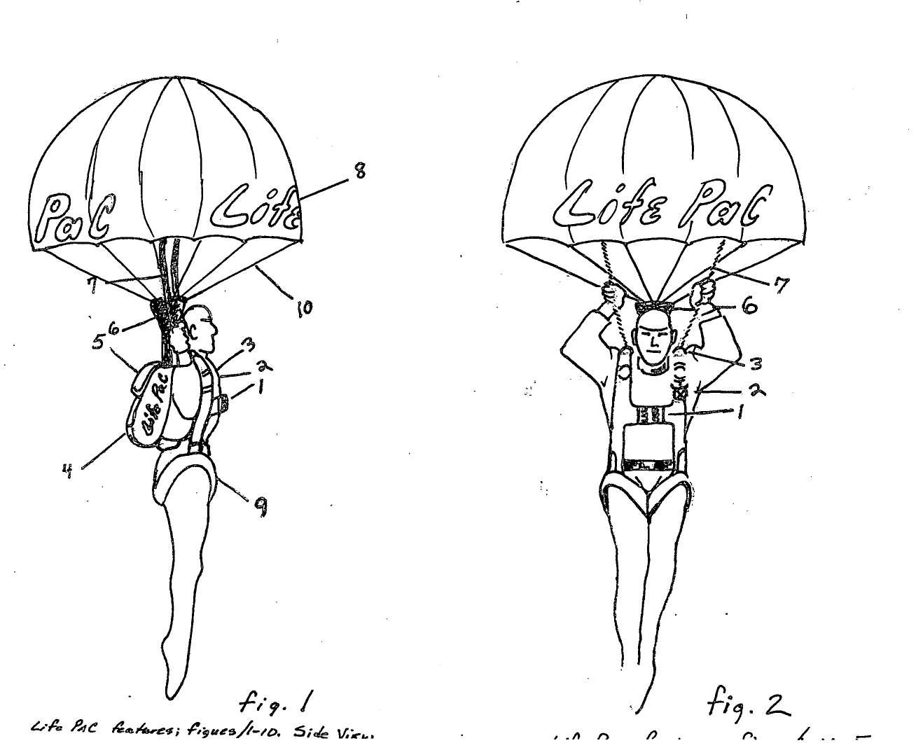

Shows a side and front schematic diagram of the parachute invention in FIG. 1 and FIG. 2 with canopy in an extended position according to the present invention.

### DETAILED DESCRIPTION OF THE PREFERRED EMBODIMENTS

The present invention relates to parachutes and essentially has for its objective to provide certain new and useful improvements in the construction and operation of such devices.

It is one objective of the present invention to provide an improvement in parachutes of the know type, whereby it is possible to attain a quicker filling of air and inflation of canopy thus permitting the safe use of the parachute at smaller heights from the ground.

FIGS. 1 & 2 gives a view of the general arrangement of the improved devices placement.

The principle and operation of the improvements as described will be explained as follows: When the user attached to the improved parachute according to the invention jumps into the air, the central aperture (1) the Automatic Sensors will activate to let you know that the parachute is fasten properly and will automatically deploy the parachute to full extention (this is used in cases of panic, which insures the safety of the persons using the LifePac.

Panic after 2 seconds. (5) Single Canopy—Parachute which is designed for low altitude evacuations. The shape of the canopy could be circular. Canopy size will vary according to weight 0.69 to 0.79 (100 lbs to 200 lbs)

Diameter will be 6.76 m (20.6 ft)

Skirt Length will be 18.5 m (56.3 ft.)

Weight will be 12.6 kg (27/8 lbs)

Descent rate will be slow at 21 fps

Forward speed of 10-12 mhps

1. The Embodiment Of The Invention In Which An Exclusive Property Or Privilege Is Claimed Are Defined As Follows.
A personal, singular canopy parachute for emergency evacuation from a building or earthy structure consisting of a parachute in a carrying case, harness to fasten device on a person, automatic inflation device and manual pull cord which can be used to inflate the parachute if sensor fails to deploy the parachute.

2. Device Recited In claim.
One where-in said parachute inflates in approximately 2 seconds or less.

2. Device in claim I or any personal parachute for building evacuation consisting of a tape recorded message and written, manual to instruct users on use of device.
